(19) United States
(12) Patent Application Publication
(10) Pub. No.: US 2007/0110398 A1
(43) Pub. Date: May 17, 2007

(54) Graphical representation of programs stored in a personal video recording device

(75) Inventor: Gerardus Henricus Broeksteeg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/598,208

(22) PCT Filed: Jan. 6, 2005
(86) PCT No.: PCT/IB05/50070

§ 371 Date: Aug. 21, 2006

Related U.S. Application Data
(60) Provisional application No. 60/606,267, filed on Sep. 1, 2004.

(30) Foreign Application Priority Data
Jan. 8, 2004 (EP) 04075002.8

(51) Int. Cl. H04N 7/00

(52) U.S. Cl. 386/95

(57) ABSTRACT

A graphical display (FIG. 3) for a personal recording device. The display including a bar (38) extending in a predetermined direction. Markers (50) dividing the bar into at least two program sections and a program pointer (44).

The present application is based on Provisional Application filed in the European Patent Office, Serial No. 04075002.8, on Jan. 8, 2004.

The present application is related to application Ser. No. ______, entitled “Marking Program Boundaries In a Personal Recording Device”.

The present invention relates generally to personal video recording devices, and more particularly, to a personal recording device that generates a graphical representation of programs being stored.

Personal video recording devices have been developed in order to enhance a person's television viewing experience. An example of such a device is the TIVO product. A personal video recorder generally includes a hard disk drive that is integrated with a television encoding system. The hard disk drive usually has an area reserved to act as a buffer. The buffer is used to continually store the program currently being watched by a user. This buffering allows a user to manipulate the program being watched by a number of trick modes including rewind, fast-forward or pause.

However, in some of these personal video recorders, the buffer capacity is limited. For example, the TIVO only has a buffer capacity of thirty minutes. Therefore, if such a device is paused for more than thirty minutes, a user will not be able to view the entire portion of the program missed.

In view of the above, the present invention is directed to a graphical display for a personal recording device. The graphical display including a bar extending in a predetermined direction. Markers dividing the bar into at least two program sections and a program pointer.

The present invention is also directed to a method of displaying a video signal. The method includes the video signal being retrieved. A graphical display being generated including a bar extending in a predetermined direction and divided into at least two program sections. The graphical display being inserted into the video signal. Further, the video signal being output.

The present invention is also directed to a personal video recording device. The device including a buffer for storing a video signal. An audio and video coding unit for retrieving and decoding the video signal, generating a graphical display including a bar extending in a predetermined direction and dividing the bar into at least two program sections, inserting the graphical display into the video signal. Further, a switch for outputting the video signal.

Referring now to the drawings where like reference numbers represent corresponding parts throughout:

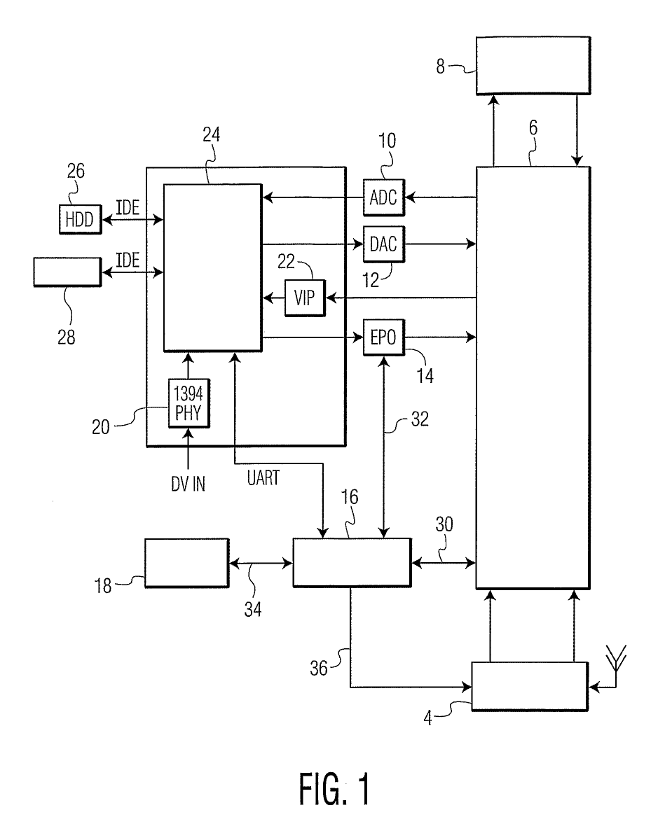

FIG. 1 is a diagram showing one example of a personal video recording device according to the present invention;

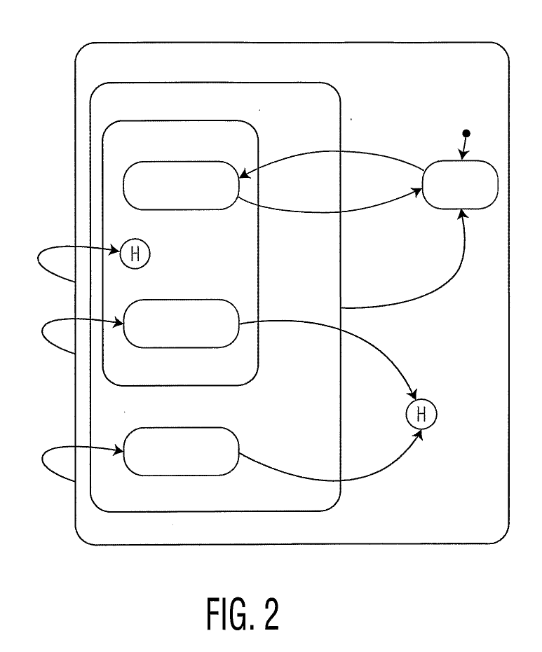

FIG. 2 is a diagram showing examples of the different graphical display modes of the personal video recording device;

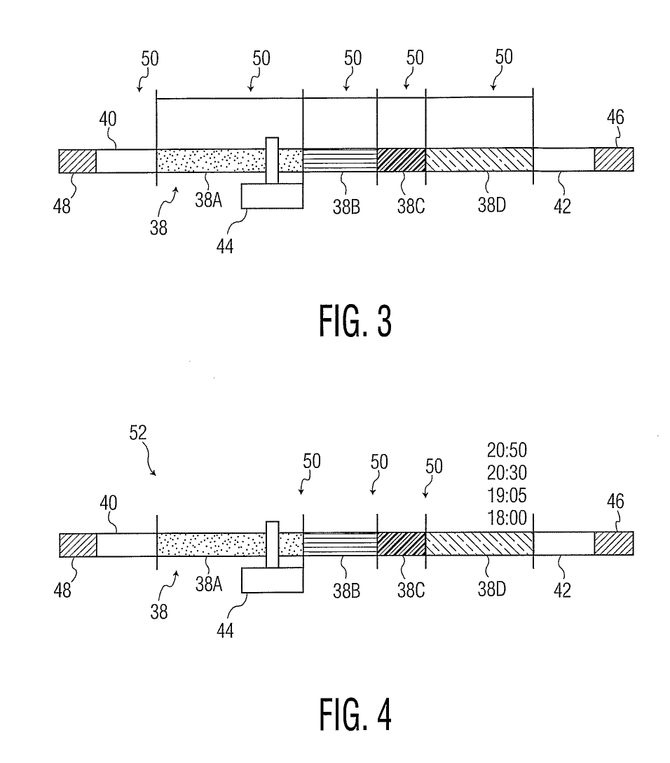

FIG. 3 is one example of a time shift buffer display according to the present invention;

FIG. 4 is another example of a time shift buffer display according to the present invention;

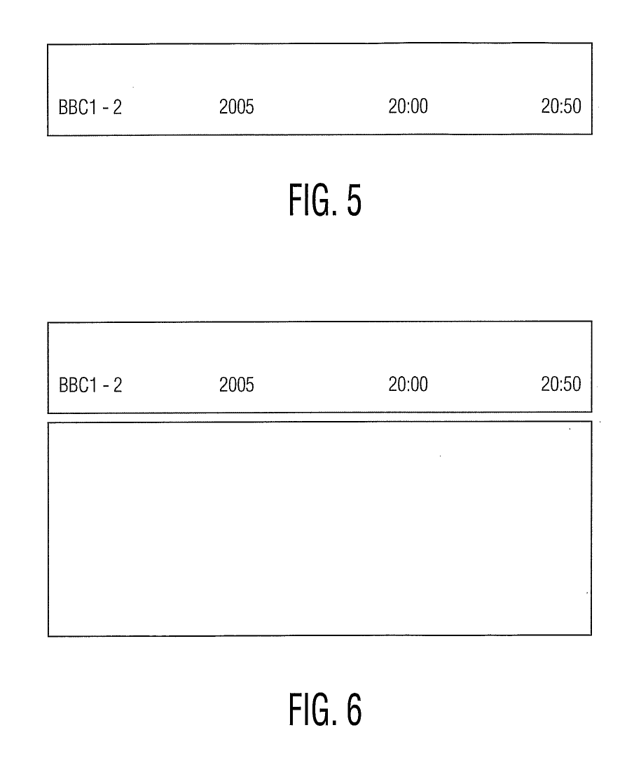

FIG. 5 is one example of a program medadata display according to the present invention; and

FIG. 6 is another example of a program medadata display according to the present invention.

One example of a personal video recording device according to the present invention is shown in FIG. 1. As can be seen, a tuner 4 is included for receiving a television signal. The tuner 4 will enable a user to select the channel to be recorded and provide an audio and video component corresponding to the selected input signal. In this example, the tuner 4 is analog tuner capable of being used in any broadcast or cable system. However, in other examples, the tuner may be a digital tuner.

Connectors 8 are also included to provide an alternative input signal to the device. Examples of alternative inputs are other video signals from other sources such as a video camera, DVD player, VCR or a set top box device. The connectors 8 also provide outputs from the device. An example of such an output would be a television or a monitor to display the program recorded. Both the tuner 4 and connectors 8 are input to an audio/video IO matrix switch 6. During operation, the matrix switch 6 selects an input signal from either the tuner 4 or connectors 8 based on user input. The matrix switch 6 then routes the selected signal to the rest of the device. The matrix switch 6 will also route an output signal from the device to the connectors 8.

An analog to digital converter 10 is included to convert the audio component of the input signal to digital. A digital to analog converter 12 is also included to convert the audio component of the output signal to analog. A video input processor 22 is also included to process the video component of the input signal. The video input processor 22 determines the format of the video component. For example, the video component may be a RGB, YUV signal . . . etc. It is necessary to know this in order to later compress the video component. The video input processor 22 also extracts information from the video component such as copy protection status or whether the video component is a PAL or NTSC signal. Further, the video input processor 22 will also convert the video component of the input signal to digital.

In this example, the audio and video components are converted from analog to digital and vice versa. However, in other examples where the input signal is digital this will not be necessary.

As can be seen, the analog to digital converter 10, digital to analog converter 12 and video input processor 22 are connected to an audio/video decoder and encoder 24. The audio/video decoder and encoder 24 is used to compress the audio and video component of the input signal before being recorded on one of the storage devices. The audio/video decoder and encoder 24 is also used to de-compress the audio and video component of the output signal received from one of the storage devices. In one example, the audio/video decoder and encoder 24 will implement the MPEG-2 coding scheme. However, in other examples, other schemes may be used such as MPEG-1, MPEG-4 or other suitable coding scheme.

The audio/video decoder and encoder 24 is also used for a number of other functions. For example, the audio/video decoder and encoder 24 is also used to control the two storage devices 26,28. Further, the audio/video decoder and encoder 24 is also used to generate the graphics to support the devices different graphical display modes. The audio/video decoder and encoder 24 will generate these graphics and insert the graphics in the video component of the output signal. Therefore, the graphics will appear as an overlay on the video when the output signal is being displayed. As will be described in more detail below, the devices different graphical display modes including time shift buffer displays and program medadata displays.

It should be noted that the audio/video decoder and encoder 24 and video input processor 22 may be implemented as separate units. Alternatively, the audio/video decoder and encoder 24 and video input processor 22 may be implemented as a single unit such as a Chrysalis hardware platform. A 1394 physical layer (PHY) 20 is also connected to the audio/video decoder and encoder 24. The 1394 PHY will enable the device to be connected to a 1394 network so that digital video (DV) data may also be received and stored in the device.

The device also includes two storage devices including hard disk drive 26 and a DVD recorder 28. In one example, the DVD recorder 28 is a DVD+RW recorder. However, in other examples, the DVD recorder may be embodied by a DVD+R, DVD-R or a DVD-RW recorder.

A portion of the storage space in the hard disk drive 26 is set aside as a buffer that is used to continuously store the input signal selected by the user. This buffer is more particularly described as a time shift buffer since it enables a user to pause, rewind or fast-forward from an earlier portion of the input signal. The amount of the space set aside as the time shift buffer will be a factor in determining the capacity of the buffer. The coding scheme will be another factor that affects the capacity of the time shift buffer. For example, a coding scheme that has a higher level of compression will increase the capacity of the buffer. The size of the time shift buffer can be set based on user input. The size of the time shift buffer may be set to a size of one, two, three, six hours or any other suitable size. The rest of the space in the hard disk drive 26 may be used as additional storage. For example, the contents of the time shift buffer may be transferred to this other space. Further, camera recordings, direct recordings or DVD images from a DVD disc may also be stored on the space not reserved as the time shift buffer on the hard disk drive 26.

The DVD recorder 28 may be used to provide more permanent storage. For example, the contents of the hard disk drive 26 may be recorded on DVD disk by the DVD-recorder 28. Further, the input signal selected by the user may also be recorded on DVD disk by the DVD recorder 28.

Connected between the audio/video decoder and encoder 24 and the IO matrix switch 6 is an electronic program guide (EPG) unit 14. The EPG unit 14 will extract any EPG information included in the input signal and store it in an internal cache. If the input signal is an analog television signal, the EPG information will be included in the vertical blanking interval of the input signal. If the input signal is a digital signal, the EPG information may be included in a separate channel or sideband. For example, in the Digital Video Broadcasting (DVB) format, the EPG information is included in event information tables (EIT).

During operation, the EPG unit 14 will use the extracted information to generate graphics for an EPG display. The EPG graphics will be inserted into the video component of the output signal by the EPG unit 14 so that the EPG may be shown on a display. Further during operation, the EPG unit 14 will route the video component back to the IO matrix switch 6 even when an EPG is not inserted. Further, the EPG unit 14 will also provide information about the program being recorded to the controller. This information may include, but not limited to, program name, genre, start time and duration of the program.

A controller 16 is included that controls various elements within device such as the tuner 4, IO matrix switch 6, EPG unit 14 and the audio/video decoder and encoder 24. A front panel 18 of the device is connected to the controller 16 by a bus 34. The front panel 18 includes a display and keys. The display shows information about the device such as the current channel being recorded. The keys are similar to ones that would be on a remote control such as the channel changer or EPG navigation keys.

During operation, user inputs may be sent to the controller 16 via a remote control or the front panel 18. As can be seen, the controller 16 is connected to the IO matrix switch 6 by another bus 30. During operation, the controller 16 will tell the IO matrix unit 6 which input signal to select based on user input. The controller 16 is also connected to the tuner 4 by another bus 36. The controller 16 will also set the channel of the tuner 4 based on user input. The controller 16 is also connected to the EPG unit 14 by another bus 32. During operation, the controller 16 will start and stop the EPG unit 14. The controller 16 will also relay navigation commands to the EPG unit 14 that were input by the user via the EPG navigation keys. This will enable a user to scroll up and down the EPG being displayed. The EPG unit 14 will also provide EPG information to the controller 16 such as program name, genre, start time and duration of the program being recorded. This will enable the controller 16 to detect when a program change occurs in the input signal.

The controller 16 is also connected to the audio/video decoder and encoder 24. The controller 16 will tell the audio/video decoder and encoder 24 when to encode the input signal and decode the output signal. The controller 16 will also provide EPG information to the audio/video decoder and encoder 24 so that it may also be stored on the hard disk drive 26. As previously described, this information includes program name, genre, start time and duration of the program being recorded.

The controller 16 will also tell the audio/video decoder and encoder 24 of any changes in the input signal such as a channel change or program change. Thus, during operation, the audio/video decoder and encoder 24 will then insert a program marker in the buffer of the hard disk drive 26 indicating where these changes occur if certain conditions are met. The details of this will be described in detail below.

The controller 16 may be implemented by a programmable microprocessor. Further, the buses 30,32,34,36 may be implemented by a standard bus such as an I²C bus.

During operation, the user will select the input signal to be recorded by the device by way of a remote control or front panel 18. As previously described, a television signal from either the tuner 4 or an alternative signal from the connectors 8 may be selected. If the tuner 4 is selected, the user will select the channel to be recorded by way of a remote control or front panel 18. The controller 16 will then set the channel of the tuner 4 to the one selected by the user. The controller 16 will also tell the IO matrix switch 6 to take the input from the tuner 4. Thus, an audio signal component and video signal component corresponding to the selected channel will be input into the IO matrix switch 6. The IO matrix switch 6 will then route the audio component to the analog to digital converter 10 and the video component to the video input processor 22.

The EPG unit 14 will also begin to extract the EPG information associated with the selected channel and provide this information to the controller 16. As previously described, this information includes program name, genre, start time and duration of the program being recorded. The analog to digital converter 10 will convert the audio component into a digital signal. The video input processor 22 will process the video component including converting it into digital. The digital outputs from the analog to digital converter 10 and the video input processor 22 are then provided to the audio/video decoder and encoder 24. The audio/video decoder and encoder 24 will begin to compress these inputs under the direction of the controller 16.

After being compressed, the audio and video components from the audio/video decoder and encoder 24 will be output to the hard disk drive 26 to be stored in the time shift buffer along with EPG information from the controller 16. The input signal will be continually processed and stored in the time shift buffer as described above until the capacity of the time shift buffer is exceeded. As the capacity of the buffer is exceeded, the oldest portion of the input signal will be discarded and the more recent portion will be stored.

Further, the audio/video decoder and encoder 24 will also insert program markers into the time shift buffer if the controller 16 detects a program change. A program change may include when a user changes the channel of the input signal or if a new program starts on the same channel.

For example, if the user requests a channel change, the controller 16 will change the channel of the tuner 4 to the one requested by the user. The controller 16 will then tell the audio/video decoder and encoder 24 to insert a program marker in the time shift buffer at the point where the change occurred. In one example, a program marker will be inserted no matter how long the tuner 4 stays on the new channel. However, in another example, a program marker will only be inserted if the tuner 4 stays on the new channel for a predetermined period of time and the new program has a duration greater than the predetermined time period. This predetermined period of time may be 20, 30, 60 or 120 seconds.

During operation, if a new program starts in the same channel, the EPG unit 14 will provide information to the controller 16 about the new program. This will enable the controller 16 to detect this program change. The controller 16 will then tell the audio/video decoder and encoder 24 to insert a program marker in the time shift buffer at the point where the program change occurred. In one example, a program marker will be inserted no matter how long the duration of the new program. However, in another example, a program marker will only be inserted if the new program has a duration of a predetermined period of time. This predetermined period of time may be 20, 30, 60 or 120 seconds.

In storing the input signal in the time shift buffer other information may be included. In one example, a characteristic point information (CPI) file may also be stored in the time shift buffer along with the program markers, compressed audio and video components. The CPI file will describe how the audio information, video information and the program markers are organized on the hard disk drive 26. This will enable the information to be randomly accessed and to use the fast forward or reverse modes. The CPI file will also indicate what part of the input signal is copy-protected and what compression mode is used.

As described above, the program markers inserted into the time shift buffer will indicate that a program change has occurred in the input signal such as when the user changes the channel or when a new program starts in the same channel. These program markers will enable a user to quickly navigate within the time shift buffer. For example, the user will be able to jump from marker to marker to see the different programs recorded in the time shift buffer. In on example, a single but ton on a remote control could be used to move from marker to marker instead of using a fast-forward or rewind operation.

Examples of the different graphical display modes of the personal video recording device is shown in FIG. 2. As can be seen, in this example there are four states. In a “NO OSD” state, there are no graphics displayed. In a “Default TSB” state, a graphical representation of the default time shift buffer (TSB) is displayed, as shown in FIG. 3. In an “Extended TSB” state, a graphical representation of the Extended TSB is displayed, as shown in FIG. 4.

In a “Program metadata” state, information about a selected program is displayed, as shown in FIGS. 5-6. In these modes, the graphics may be displayed transparent to the video.

Regarding the states of FIG. 2, transitions from one state to another may be caused by a user pressing a key on the remote control or by a timer that expires. From any state, the system goes to the “Extended TSB” state when an OVERVIEW key is pressed. When a BACK key is pressed from that state, the system reverts to the state it was in before the OVERVIEW key was pressed.

Similarly, from any state, the system goes to the “Program metadata” state when a MORE-INFO key is pressed. When the BACK key is pressed from that state, the system reverts to the state it was in before the MORE-INFO key was pressed. If the system is in the ‘Program metadata’ state or in the ‘No OSD’ state, the system goes to the last presented TSB state (either “Default TSB” or “Extended TSB”) if the user initiates time shifting. If the system is already in one of the TSB states, then the state in which the system is, remains the same. If any OSD is visible and the user presses the INFO key, then the system goes to the “No OSD” state and thus removes all graphical displays from the screen. If the system is in a state that the user did not explicitly recall, then the graphical displays are removed after a certain period of time, unless the user is navigating in the Time Shift Buffer.

One example of the Default TSB is shown in FIG. 3. As can be seen, the Default TSB includes a bar 38 that extends in a predetermined direction. In this example, the bar 38 extends horizontally. However, the present invention contemplates other directions such as vertically or diagonally. The bar 38 is a graphical representation of the programs stored in the time shift buffer of the hard disk drive. In this example, the programs are stored from right to left on the bar 38. The visual length of the bar 38 is “360” pixels. This means that one pixel in a three-hour TSB corresponds with one minute of recorded data. For a higher definition display, the visual length of the bar 38 may be “2024” pixels.

The bar 38 is also divided into program sections 38A,38B,38C,38D by markers 50 representing the different programs stored in the time shift buffer of the hard disk drive. The position of the markers 50 correspond to the program markers inserted into the time shift buffer of the hard disk drive. As previously described, a program marker is inserted if a channel or program change occurs.

The program sections 38A,38B,38C,38D are color coded for a number of functions. For the purpose of this discussion color coded means using different colors, different patterns such as dots or lines or a combination of colors and patterns. For example, the program sections 38A,38B,38C,38D are color coded to represent the genre of the stored programs such as sports, news, comedy, etc. For example, blue may correspond to sports, yellow may correspond news and green may correspond comedy. The program sections 38A,38B,38C,38D may also be color coded to indicate that no signal was available at the time of recording. Since the Time Shift Buffer is a real time buffer, the device cannot simply stop recording when there is no signal. Thus, in this situation, nothing is recorded and the program section corresponding to this time will be coded with another color such as black.

Further, the program sections 38A,38B,38C,38D may also be color coded to indicate that a particular program is copy-protected. This means that the program cannot be copied onto the hard disk. Sometimes only parts of a program are copy-protected and that too can be reflected in the bar. There are two different copy-protection attributes (“copy once” and “copy never”) that can be represented differently as required. In one example, copy protection would be indicated by little squares across the length of the program section.

The program sections 38A,38B,38C,38D may also be color coded to indicate that a program is marked to be saved. Normally, the title would fall off the buffer at some point in time, but it can also be saved at the user's request. Therefore, a program to be saved will be color coded with another color such as red.

As can be further seen, above each program section 38A,38B,38C,38D is the name of the program. Since there is limited space to show the names, there are a few rules to display the name. If the name fits in the available space, then the entire name is displayed.

If there are less than 40 pixels available, no name is displayed at all. If less than three characters fit in the available space, no name is displayed at all. As much characters of the name as possible are displayed.

The Default TSB also includes playback pointer 44. The playback pointer 44 points to the portion of the TSB that is being played back or displayed. In this example, if the current tuner signal is being displayed, the playback pointer 44 is at the far right of the bar 38. During operation, there are several ways a user may navigate in the TSB. Pressing a left or right arrow key once will move the playback pointer in the direction of the arrow key by one frame. Holding down an arrow key accelerates the speed with which the playback pointer moves. The strategy is to cross the entire TSB in 10 seconds.

Pressing a Next or Previous key jumps to a chapter marker or title marker, depending on the state of the Title/Chapter (T/C) preference. This preference can be toggled by pressing a T/C key on the remote control. A Next key moves to the beginning of the next chapter/title, whereas the Previous key moves to the beginning of the current title. Pressing the Previous key again within 5 seconds, moves it to the previous title/chapter.

Up/Down arrow keys move the playback pointer to the beginning of the next or previous program. Skip keys move the playback pointer forward or backward with a user-specified amount of time. The user can specify independent forward and backward skip times between 0 and 300 seconds. Trick modes are also used to fast forward, fast backward, slow forward, slow backward, etc. If a beginning of the buffer is reached in the backward mode, the system reverts to normal playback. If the end of the time shift buffer is reached, the tuner signal currently being recorded is shown.

At the ends of the bar 38 is a start time graphic 40 and an end time graphic 42. If the time shift buffer is not completely filled, the start time is the time the device started recording. If the buffer is completely filled, the start time corresponds to the time of the oldest recording, which is the current time minus the size of the buffer in hours. In this example, it would be on the left hand side. The end time corresponds to the time of the current recording.

At the ends of the bar 38 is also an in-flow animation 46 and an out-flow animation 48. The in-flow animation 46 moves in the direction of data flowing into the time shift buffer and the out-flow animation 48 moves in the direction of data flowing out of the time shift buffer. In this example, the in-flow animation 46 and an out-flow animation 48 both move to the left. If the TSB is not completely filled and data is not flowing out, the animation stops. If the program at the end of the buffer is marked to be saved, the animation will be red instead of blue. Further, if the program at the beginning of the buffer is marked to be saved, then the animation will be red instead of blue.

One example of the Extended TSB is shown in FIG. 4. As can be seen, the Extended TSB is the same as the Default TSB except that program information list 52 is included. The program information list 52 includes information about the programs that correspond to each of the program sections 38A,38B,38C,38D. In this example, the program information includes the channel, name and start time of each program. If the name does not fit, it will be displayed with an ellipsis ( . . . ) to indicate that the name is actually longer. If a program is marked to be saved, then that would be indicated with a dot between the channel name and the program title.

One example of a program medadata display is shown in FIG. 5. In this mode, the metadata for the currently played program is displayed. As can be seen, the name of the program is at the top-left. The genre of the program at the top right hand side. The channel from which the program originates is at the bottom left side. The recording date (or the current date if is a live program) of the program is to the right of the channel name.

The start time of the program is to the right of the recording date. It shows the time when the program starts. The end time of the program is to the right of the start time. It shows the time when the program ended. If the program is a live program, then the end time is empty. Other implementations might comprise the EPG end time, the programmed end time or the current time.

Another example of a program medadata display is shown in FIG. 6. As can be seen, this display is the same as the previous except that an extended program information area. This extended area provides space for additional information such as program summaries.

While the present invention has been described above in terms of specific examples, it is to be understood that the invention is not intended to be confined or limited to the examples disclosed herein. Therefore, the present invention is intended to cover various structures and modifications thereof included within the spirit and scope of the appended claim.

1. A method of displaying a video signal, comprising the steps of:
retrieving the video signal,
generating a graphical display including a bar extending in a predetermined direction and divided into at least two program sections,
inserting the graphical display into the video signal; and
outputting the video signal.

2. The method of claim 1, wherein the program sections are defined by markers.

3. The method of claim 2, wherein the markers correspond to either a program change or a channel change.

4. The method of claim 1, wherein the program sections are color coded to indicate genre of a program.

5. The method of claim 1, wherein at least one of the program sections is color coded to indicate a program is copy-protected.

6. The method of claim 1, wherein at least one of the program sections is color coded to indicate a program is to be saved.

7. The method of claim 1, wherein at least one of the program sections is color coded to indicate no signal is available.

8. The method of claim 1, wherein the graphical display further includes a program pointer.

9. The method of claim 1, wherein the graphical display further includes a start time graphic and an end time graphic.

10. The method of claim 1, wherein the graphical display further includes an in flow animation and an out flow animation.

11. A personal video recording device, comprising:
a buffer for storing a video signal;
an audio and video coding unit (24) for retrieving and decoding the video signal, generating a graphical display including a bar extending in a predetermined direction and dividing the bar into at least two program sections, inserting the graphical display into the video signal; and
a switch (6) for outputting the video signal.

12. The device of claim 11, wherein the program sections are defined by markers.

13. The device of claim 12, wherein the markers correspond to either a program change or a channel change.

14. The device of claim 11, wherein the program sections are color coded to indicate genre.

15. The device of claim 11, wherein at least one of the program sections is color coded to indicate a program is copy-protected.

16. The device of claim 11, wherein at least one of the program sections is color coded to indicate a program is to be saved.

17. The device of claim 11, wherein at least one of the program sections is color coded to indicate no signal is available.

18. The device of claim 11, wherein the graphical display further includes a program pointer.

19. The device of claim 11, wherein the graphical display further includes a start time graphic and an end time graphic.

20. The device of claim 11, wherein the graphical display further includes an in flow animation and an out flow animation.

21. A graphical display for a personal recording device, comprising:
a bar extending in a predetermined direction,
markers dividing the bar into at least two program sections, and
a program pointer.
